(19) United States
(12) Patent Application Publication
(10) Pub. No.: US 2019/0303796 A1
(43) Pub. Date: Oct. 3, 2019

(54) Automatically Detecting Frivolous Content in Data

(71) Applicant: Microsoft Technology Licensing, LLC, Redmond, WA (US)

(72) Inventors: Kavitha BALASUBRAMANIAN, Issaquah, WA (US); Eder Apolinar CASTRO PELAYO, Issaquah, WA (US); Shishir ABHYANKER, Renton, WA (US); Ashish VYAS, Kenmore, WA (US); Rakesh MOHAN, Issaquah, WA (US); Sasya KETHIREDDY, Sammamish, WA (US); Prabhu JAYARAMAN, Bothell, WA (US)

(21) Appl. No.: 15/937,460

(22) Filed: Mar. 27, 2018

(51) Int. Cl. G06N 99/00; G06N 7/00

(52) U.S. Cl. CPC G06N 99/005; G06N 7/005

(57) ABSTRACT

Described technologies automatically evaluate contact information and other submitted textual content to identify suspect data. Different data validation technologies alone or in combination identify frivolous content such as profanity, gibberish, and mismatched meanings. These technologies may perform regular expression recognition, naïve Bayes or other probabilistic classifications, named entity recognition, and subsidiary functions such as data cleaning, gibberish generation, and model training. A predictor value indicates how likely it is that the submitted data is valid input, e.g., a valid person name or valid company name, as requested. A trained machine learning based content characterizer embodies rules for content characterization, including implicit rules produced by supervised machine learning. Some content characterizers identify suspect content other than range violations or data type violations, by identifying profanity or gibberish. Various types of training set data and its advantages and disadvantages are discussed. Aspects of gibberish generation are also taught.

### BACKGROUND

In computer science, data validation attempts to ensure that data is clean, correct, and useful. Data validation may include or be preceded by data cleansing, which tries to detect and either correct or remove data that is corrupt or inaccurate. Effective data validation increases the efficiency and accuracy of a data processing system by reducing the wasteful use of computational resources to process data that is ultimately determined unsuitable for the purposes for which it was sought. Effective data validation may also improve security by preventing buffer overflows and other cyberattacks.

Automatic data validation implementations use a variety of tools and techniques, with varying degrees of success. For example, automatic data validation may use syntactic analysis, lexical analysis, and other parsing techniques to determine the primitive data type of an input (e.g., integer, float, or string), which is then compared to the expected primitive data type. Certain characters may be required, e.g., an ‘@’ in an email address, or be excluded, e.g., non-alphabetic characters in a person's name. Sometimes leaving an input field empty is permitted but in other cases a value must be provided or the input is invalid. Data validation tools may also check whether the number of characters entered is correct, e.g., for a postal code or telephone number. Sometimes an input value can be tested against an acceptable range, e.g., an age cannot be negative, a number of days worked per year must be in the range from 0 to 366, and a divisor should not be zero. Sometimes data validation software checks two or more values of input data against one another for consistency, e.g., a group of percentages should total 100. Sometimes the validity of an input can be tested by automatically checking an external source, e.g., the domain portion of an email address should be resolvable to an IP address using the Domain Name System, and in many cases a filename should refer to an existing file. Some data inputs, such as International Standard Book Numbers, include a checksum which can be recalculated from part of the data and then compared to the checksum submitted with the data; hashes can be similarly tested.

### SUMMARY

Some technologies described herein are directed to the technical activity of automatically evaluating contact information to identify suspect data. Some teachings are directed to effectively and efficiently combining different data validation technologies to identify frivolous content such as profanity, gibberish, and mismatched question-answer meanings. Technical mechanisms are described for characterizing data with a predictor value that indicates how likely it is that the data is valid. Specific technical tools and techniques are described in response to the challenge of automatically identifying gibberish, the challenge of automatically distinguishing profanity from non-profane words with similar or overlapping spelling, and the challenge of reducing the need for human review of data that was submitted as a prank or in bad faith. Technical improvements provided by some embodiments include more efficient detection of gibberish in data, better avoidance of false positives when detecting profanity in data, and more cost-effective data validation through previously unachieved automation capable of rapid frivolity detection at production scale. Other technical activities and advantages pertinent to teachings herein will also become apparent to those of skill in the art.

Some embodiments described herein provide or use a trained machine learning based content characterizer (TMLBCC) which embodies rules for content characterization. The rules were produced by supervised machine learning based on a training set that contains data labeled as prohibited content and other data labeled as allowed content. The TMLBCC performs content characterization by applying rules to generate prohibition predictor values which it then associates with the content. Some content characterizers identify suspect content other than range violations or data type violations, by identifying content such as profanity or gibberish that is not only suspect but also frivolous. Some embodiments include training a machine learning model to identify frivolous content through supervised machine learning which is based on training set data. Various types of training set data are discussed, along with advantages and disadvantages of particular kinds of training set data. Aspects of gibberish generation are also taught.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system and also illustrating a configured storage medium;

FIG. 2 is a block diagram illustrating aspects of a data validation architecture, including one or more data sources, a content characterization system which employs a machine learning model, and training data for supervised training of the machine learning model;

FIG. 3 is a block diagram further illustrating aspects of content characterization systems;

FIG. 4 is a block diagram further illustrating aspects of gibberish generation;

FIG. 5 is a block diagram illustrating different kinds of content discussed herein and their relationship to one another;

FIG. 6 is a diagram illustrating another example of a data validation architecture;

FIG. 7 is a flowchart illustrating example content characterization methods;

FIG. 8 is a flowchart illustrating example content characterizer creation methods; and

FIG. 9 is a flowchart further illustrating steps in some methods.

### DETAILED DESCRIPTION

Overview

Sometimes an innovation created to solve a particular problem can also be used, perhaps with some creative adaptation and insight, to solve other problems. In the present case, the inventors faced the particular problem of how to efficiently distinguish valid marketing leads from time-wasting submissions that lacked usable data. While developing and refining their technical solutions to this original problem, the inventors created tools and techniques whose beneficial use is not limited to the specific problem of validating marketing leads. But understanding the original challenges faced may aid understanding of the innovations those challenges led the inventors to create.

Marketing leads entered an internal marketing system when people signed up for trials, events, webinars, and other events by providing their name, company name, email and phone number. These possible leads were then enriched, validated, prioritized, and then sent to a sales group so that people in the sales group could connect with the leads who are most probable to make a product or service purchase. Genuine leads who are interested in product and service purchases would enter valid information, but a lot of form submissions contain frivolous data such as keyboard gibberish and profanity. A goal was to filter out these frivolous leads before sending received data onward to the sales group.

As discussed herein, the inventors designed and implemented a hybrid approach for detecting frivolous values in form submissions. The approach is hybrid in that it involves orchestrating between three validation service providers, namely, a static rules provider, a naïve Bayes based machine learning provider, and an entity recognition provider. This approach was applied to social network forms and other form submissions, such as event signup and registration forms, contact us forms, contact me, webinars, product signups, trial signups, product enquiries, promotional offer signups, patient portals, and retail account creation forms.

One challenge was how to automatically determine quality and detection of invalid content in company and person name fields in form submissions. Much of the invalid content includes profanity, keyboard gibberish and other unrelated content in these fields. Automation was required as a practical matter because of the enormous amount of data and the lost opportunities when leads are not promptly followed.

Some previous solutions used a static pattern for detecting profanity, but they do not detect keyboard gibberish effectively, e.g., gibberish such as asdjfhasfh, iqueytiqueyt, QS+DCF′VBNM, 3e4rf6yh78ujk9oikl, kjh\hat{ }%$*&%JF, and so on. For e.g. adding a static rule for detecting %asdf% does not detect other forms of keyboard gibberish. Some previous solutions use machine learning models that use character level n-grams and naïve Bayes rules can detect some gibberish, but they generate false positives and do not detect other kinds of invalid content.

In one implementation, the inventors modified the approach used in the past by chaining together three different approaches: a profanity rules based model, a naïve Bayes based machine learning model, and an entity recognition model, to holistically detect frivolous content. The inventors also modified an existing machine learning based model approach by including keyboard gibberish and profanity in the training data, and in particular by not generating character n-grams for profanity, thereby reducing the false positives. The entity recognition module helps remove content which is valid in other contexts but invalid to the particular field in which it was submitted, e.g., an address or phone number or personal name submitted in a company name field.

Some embodiments described herein may be viewed by some people in a broader context. For instance, concepts such as characterization, meaning, prediction, profanity, rules, and training, may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to automatically predict data validity given the extremely large—effectively infinite—number of different text strings that can be submitted in a web form or from another data source. Other media, systems, and methods involving characterization, meaning, prediction, profanity, rules, or training are outside the present scope. Accordingly, vagueness, mere abstractness, lack of technical character, and accompanying proof problems are also avoided under a proper understanding of the present disclosure.

Technical Character

The technical character of embodiments described herein will be apparent to one of ordinary skill in the art, and will also be apparent in several ways to a wide range of attentive readers. Some embodiments address technical activities that are rooted in computing technology and improve the functioning of computing systems by training the machine learning models which control operation of those systems, for instance, or by orchestrating data validation operations performed in those systems, thereby making the systems better at detecting invalid data.

Some embodiments include technical components such as computing hardware which interacts with software in a manner beyond the typical interactions within a general purpose computer. For example, in addition to normal interaction such as memory allocation in general, memory reads and writes in general, instruction execution in general, and some sort of I/O, some embodiments described herein implement machine learning, training data generation (e.g., gibberish training data), and other steps disclosed herein.

Technical effects provided by some embodiments include more efficient detection of gibberish, better avoidance of false positives when detecting profanity, and more cost-effective data validation through leveraging existing Bayes classification code and regular expression recognition code.

Some embodiments include technical adaptations such as orchestrated data validation service providers, and coordinated prohibition predictor values.

Other advantages based on the technical characteristics of the teachings will also be apparent to one of skill from the description provided.

Acronyms and Abbreviations

Some acronyms and abbreviations are defined below. Others may be defined elsewhere herein or require no definition to be understood by one of skill.

ACL: access control list

ALU: arithmetic and logic unit

API: application program interface

BCE: before common era

BIOS: basic input/output system

CD: compact disc

CPU: central processing unit

CRM: customer relationship management

DVD: digital versatile disk or digital video disc

FPGA: field-programmable gate array

FPU: floating point processing unit

GPU: graphical processing unit

GUI: graphical user interface

GUID: globally unique identifier

IDE: integrated development environment, sometimes also called “interactive development environment”

IP: internet protocol

ML: machine learning

OS: operating system

RAM: random access memory

ROM: read only memory

SDK: software development kit

SQL: structured query language

URL: uniform resource locator

VM: virtual machine

Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Quoted terms are being defined explicitly, but a term may also be defined implicitly without using quotation marks. Terms may be defined, either explicitly or implicitly, here in the Detailed Description and/or elsewhere in the application file.

As used herein, a “computer system” may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include any code capable of or subject to scheduling (and possibly to synchronization), and may also be known by another name, such as “task,” “process,” or “coroutine,” for example. The threads may run in parallel, in sequence, or in a combination of parallel execution (e.g., multiprocessing) and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, and so on.

“Kernels” include operating systems, hypervisors, virtual machines, BIOS code, and similar hardware interface software.

“Code” means processor instructions, data (which includes constants, variables, and data structures), or both instructions and data. “Code” and “software” are used interchangeably herein. Executable code, interpreted code, and firmware are some examples of code. Code which must be interpreted or compiled in order to execute is referred to as “source code”.

“Program” is used broadly herein, to include applications, kernels, drivers, interrupt handlers, firmware, state machines, libraries, and other code written by programmers (who are also referred to as developers) and/or automatically generated.

“Service” means a consumable program offering in a cloud or client-server computing environment or other network environment.

As used herein, “include” and “contain” each allows additional elements (i.e., includes means comprises, contains means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses resource users, namely, coroutines, threads, tasks, interrupt handlers, application processes, kernel processes, procedures, and object methods, for example. “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment. Operations such as obtaining submitted data from a buffer, comparing a string to a regular expression, determining the data category of a submitted string, predicting which classification a given input is ultimately given based on training data, and characterizing the contents of thousands of daily data submissions fast enough to prevent a growing backlog, are understood herein as requiring and providing speed and accuracy that are not obtainable by human mental steps, in addition to their inherently digital nature (a human mind cannot interface directly with RAM or other digital storage to retrieve the necessary data). This is well understood by persons of skill in the art, but others may sometimes need to be informed or reminded of the facts. Unless stated otherwise, embodiments are presumed to be capable of operating at scale in production environments, or in testing labs for production environments, as opposed to being mere thought experiments.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(s)”, “(es)”, or “(ies)” means that one or more of the indicated feature is present. For example, “processor(s)” means “one or more processors” or equivalently “at least one processor”.

As used herein, “data buffer” means an area of digital memory that accepts digital input; “input” means one or more data values. A given data buffer may be a field in a web form or spreadsheet, text box in an application program user interface, an object, an XML structure, part of a data stream, or another data structure, for example. A particular data buffer has one or more data types, which is to say, it is designed or implemented or configured to accept data which is in one or more data types. A text box, for example, expects textual (character or string) input, an audio buffer expects audible data or a representation thereof, an input buffer to a handwriting recognition program expects pixels or curves or other data corresponding to handwriting, and so on. The data placed in the data buffer may be entered manually, or it may be generated by a computer program. A data buffer also has one or more expected data categories, and one or more expected languages.

A “data type” of a data buffer is either a primitive data type, or a composite of primitive data types, and may be either static (determined at compile time) or dynamic (determined at runtime). Determination of a data type is made by software, and conformance with data type constraints is enforced by software. Primitive data types vary between implementations, but typically include integer, float, string, and Boolean data types. Sometimes a distinction is made between character and string data types, but data is readily converted from character to string. Many data buffers have a single data type, but some may permit or expect a type conversion, e.g., converting a string value “57” to a corresponding integer value 57.

An “expected data category” of a data buffer is an expectation made manifest in computer code which processes input that is read from the data buffer; the code attempts to assign an interpretation to the input in order to further a functional goal of the code. Data type and data category are not the same thing. Generally, data types are defined and enforced by compilers, interpreters, or other programming language translators, whereas data categories are defined and enforced by application programs. For example, the categories denoted by “city names” and “people names” can both have a string data type, but they are different data categories if the program distinguishes between cities and people. On the other hand, a data category denoted “age” might be implemented as an integer data type in some places and as a string data type in others, but in each case the program would expect data that represents an age. The expected data category of a given buffer may change, e.g., a program may prompt first for a personal name and next for a company name, and internally place both prompt responses in the same memory buffer.

An “expected language” of a data buffer is an expectation made manifest in computer code which processes input that is read from the data buffer; the code's attempt to assign an interpretation to the input presumes the input in expressed in one or more particular languages. In many cases, an expected language is a natural language, e.g., English, Chinese, Spanish, and so on. In some cases, a data buffer may be designed to receive program source code as input, in which case the expected language may be Java, Python, C, or another programming language.

“Meaningful input” in a data buffer is input which has at least one publicly recognized meaning in the expected language of the data buffer, as evident from content in a dictionary, thesaurus, magazine, book, wiki, web page, or other publication.

“Gibberish” in a data buffer is input which is not meaningful input. In a given implementation, any string which is not found in the dictionaries employed by the implementation may be treated as gibberish. The internet may be treated as a dictionary by invoking one or more search engines to see whether results using the string in question are found.

“Profanity” (also referred to as “profane input”) in a data buffer is input that matches constraints given in a profanity file, a profanity section of a file, a profanity list, or another deterministic mechanism which serves as a profanity specification. Given a string, the profanity specification of a given implementation provides a determination whether the string includes profanity. However, a different implementation (including a modified version of the first implementation) may make a different determination. The flexibility thus provided permits users of an embodiment to tailor the choice of profanity to particular circumstances, while still providing an objective criterion for determining what constitutes profanity in a given implementation. If an input satisfies the criteria in the designated profanity specification then the input is profanity so far as the subsequent processing is concerned, and if the input does not satisfy the criteria in the designated profanity specification then the input is not profanity, regardless of any individual's subjective views.

The profanity specification may be implemented as a word list, or as a set of regular expressions, for example. Such regular expressions are sometimes referred to herein as “static rules” in contrast to the dynamic rules that result from supervised machine learning. The profanity specification may be tailored to a particular natural language, or to a dialect. Words deemed profane in one social context are not necessarily considered profane in a different social context, so an objective mechanism (the profanity specification) is used herein instead of a subjective definition such as “words that are considered offensive in polite society”.

The profanity specification determines whether an input is profane based on one or more criteria other than a result of checking numeric bounds or checking data types. For example, a data buffer labeled userAge could be bounds checked to treat negative numbers as invalid input, but −99 would not be considered profanity in that field merely because it fails a bounds check. The profanity specification would have to list “−99” as profanity, or “−99” would need to match a regular expression in the profanity specification. Likewise, a float value 3.14159 would be invalid input for userAge because an integer value is expected, but 3.14159 would not be considered profanity merely because it fails the data type check.

It is expected that profanity identified using a profanity specification will often be meaningful within the broader context of the expected language of the data buffer. Accordingly, gibberish (as defined above) is not profanity as defined here, because gibberish is not meaningful but profanity often has meaning.

“Frivolous” input in a data buffer of a processing environment is input that satisfies one or more of the following conditions: (a) the processing environment includes a profanity specification and the input is profanity according to the profanity specification, (b) the input has no publicly recognized meaning in the expected language of the data buffer, which is to say, the input is gibberish, (c) the processing environment includes multiple data categories and determines that the input is in a different data category than the current expected data category of the data buffer. In short, input that is profanity or gibberish or not in the expected data category is frivolous input.

Some additional examples illustrate these definitions.

Input Example A. “Craptown” as input to a data buffer labeled cityName is frivolous profanity when code processing the input determines that any word beginning with “crap” (case insensitive) is profanity according to the profanity specification. This input is not gibberish because it has an entry in the online Urban Dictionary. If the processing environment performs data categorization, there are two possibilities. It may occur that the data categorization places “Craptown” in the “city name” data category, for instance because it contains “town”. In this event, the input would not be frivolous by reason of belonging to an unexpected data category. Or it may be that the data categorization places Craptown in an “unknown” category because it finds no place named Craptown in its dictionary of place names, in which event the input would be frivolous by reason of belonging to different data category than the one expected.

Input Example B. “ka32876sdjfh*&\hat{ }” as input to a data buffer labeled cityName is frivolous gibberish. The space of possible gibberish strings is so large, and the difficulty of listing them all or even defining a large subset of them by regular expressions without erroneously sweeping meaningful inputs in, is so great, that the string is very unlikely to be flagged as profanity. Recall also that profanity generally has meaning, and this string has no apparent meaning in English, the expected language for cityName. The lack of meaning is confirmed by search engine results: “Your search—‘ka32876sdjfh*&\hat{ }’—did not match any documents.” This string would also be flagged as frivolous by reason of mismatched data categories, since correct data categorization would not label it as a city name.

Input Example C. “Paris” as input to a data buffer labeled countryName is unlikely to be flagged as profanity or as gibberish. But it would be flagged as frivolous by reason of mismatched data categories, in a processing environment that labeled it as a city name and treated city names as a different category than country names.

Input Example D. “1′%20or%201′%20=%201” as input to a data buffer labeled userName is unlikely to be flagged as profanity when the profanity specification is focused on swear words and similar socially offensive language, as will likely be the case in many implementations. However, the scope of profanity in a given implementation could be expanded to include strings that occur in malware or other cyberattack scenarios. This particular input matches part of a well-known SQL injection attack, which is documented in an online article titled “Testing for SQL Injection (OTG-INPVAL-005)” that is part of OWASP testing Guide v4. OWASP is the Open Web Application Security Project. So a regular expression of “%20” could be part of a profanity specification, in which case this input would be flagged as profanity. Similarly, SQL programming language reserved words such as SELECT, WHERE, UPDATE and others could be added to the list of profanity, or placed in their own list of prohibited frivolous words. More generally, the flexibility provided by using a profanity specification as the determination mechanism for identifying profanity allows profanity to be defined, in a given implementation, to include any prohibited terms or phrases, not merely those which are socially offensive.

As used herein, “rules” are decision-making factors or other decision-making criteria. Rules do not necessarily have the form {IF condition THEN action}. For example, rules may be embodied in a conditional probability model, such as a naïve Bayes classifier model, or a neural network, such as a deep learning or convolutional network. Rules are generally embodied in a system through automated supervised learning. Rules are not necessarily human readable and are not necessarily expressed in a concise explicit form in system code.

For clarity, predictor values discussed herein are typically in the range from zero to one. This does not rule out other ranges, e.g., in a given implementation predictor values could run from 0 to 100, or 10.0 to 11.0, or some other range, instead of from 0.0 to 1.0. What matters is whether the other range maps nicely to the range from zero to one. A range X of numbers is “compatible” with the range [0.0 . . . 1.0] if every distinct value in X can be mapped to a corresponding distinct value in [0.0 . . . 1.0]. In mathematical terms, X is compatible with the [0.0 . . . 1.0] if there is a 1-to-1 injection from X into the range [0.0 . . . 1.0].

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, would be deemed part of the structures identified in the application for zac widgets and would help define the set of equivalents for zac widget structures.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as accepting, applying, associating, avoiding, characterizing, classifying, comparing, executing, generating, identifying, labeling, learning, linking, obtaining, performing, predicting, producing, reading, receiving, recognizing, selecting, training, using (and accepts, accepted, applies, applied, etc.) with regard to a destination or other subject may involve intervening action such as forwarding, copying, uploading, downloading, encoding, decoding, compressing, decompressing, encrypting, decrypting, authenticating, invoking, and so on by some other party, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave outside the scope of patentable subject matter under United States Patent and Trademark Office (USPTO) interpretation of the In re Nuijten case. No claim covers a signal per se in the United States, and any claim interpretation that asserts otherwise is unreasonable on its face. Unless expressly stated otherwise in a claim granted outside the United States, a claim does not cover a signal per se.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:

100 operating environment, also referred to as computing environment

102 computer system, also referred to as computational system or computing system

104 users

106 peripherals

108 network generally

110 processor

112 computer-readable storage medium, e.g., RAM, hard disks

114 removable configured computer-readable storage medium

116 instructions executable with processor; may be on removable media or in other memory (volatile or non-volatile or both)

118 data

120 kernel(s), e.g., operating system(s), BIOS, device drivers

122 tools, e.g., anti-virus software, firewalls, packet sniffer software, intrusion detection systems (IDS), intrusion prevention systems (IPS)

124 applications, e.g., word processors, web browsers, spreadsheets

126 display screens

128 computing hardware not otherwise associated with a reference number 106, 108, 110, 112, 114

200 an example data validation architecture

202 content characterization system

204 data buffer

206 content (data)

208 trained machine learning based content characterizer (TMLBCC); training may be on-going

210 content classification rules; may be embodied in TMLBCC or a rule-based system or a neural net or another kind of content characterization system; may be implicit in the form of reproducible behavior of the system (same input and context yields same output) or may be explicit, e.g., IF-THEN form rules

212 machine learning model

214 machine learning engine, namely, code which (a) modifies the model in response to training data, and (b) provides a predictor value or other classification based on the model in response to query data

216 content associated with a predictor value, e.g., by virtue of being paired with predictor or linked to/from predictor

218 predictor value which indicates likelihood that associated content is suspect

220 content consumer, e.g., software that will perform additional processing on the content after the content's validity is assessed by the content characterization system

222 content sources, also referred to a data sources

224 web forms

226 trial signup forms or other data submissions for a software trial

228 event forms or other data submissions for a specific conference, trade show, convention, or other event

230 webinar forms or other data submissions for a webinar

232 other data submissions; note that a given data submission may be fit more than one of the examples listed 224-230

234 machine learning training set

236 training data labeled as prohibited content to configure the machine learning model to help recognize prohibited content

238 training data labeled as allowed content to configure the machine learning model to help recognize allowed content

240 n-grams (e.g., substrings of words) in training data; some n-grams may be labeled as prohibited content while other n-grams are labeled as allowed content

302 content characterization system interface which includes interface to data buffer that receives content to be characterized, may be, e.g., a web form

304 natural language identifier

306 naïve Bayes classifier

308 file(s) holding binarized machine learning model

310 regular expression (also referred to as “regex”); may be implemented, e.g., using syntax compliant with IEEE POSIX standard Basic Regular Expressions or Extended Regular Expressions

312 regular expression recognizer, namely, code which scans an input string and indicates whether part or all of the string matches any one or more previously specified regular expressions

314 profanity specification, namely, a list of literal strings or regular expressions or both, which specifies the set of strings that are currently considered profane in a content characterization system that uses the profanity specification to identify profanity

316 suspect content, namely content which is out of range, or a wrong data type, or frivolous, or more likely than not prohibited or malicious or useless for some other reason, in a given content characterization system

318 suspect content identifier, namely, either a copy of content that is suspect, or indexes or pointers or addresses that identify content that is suspect

320 gibberish generator

322 named entity

324 named entity recognizer

402 table of characters or other symbols; may be one-dimensional, two-dimensional, or n-dimensional

404 character, e.g., ASCII, Unicode, or other value interpreted as a character

406 position of a character or symbol in a table, e.g., an index or coordinates or tuple or address which identifies the location occupied by the character or symbol in the table

408 value(s) of a character or symbol; may include both an internal value in binary and a display or graphical value in pixels or vector graphics

410 symbol, e.g., an individual character, ora string of characters used as a unit, or an ideogram

412 move frequency

414 table of move frequencies

416 gibberish sequence

418 length (number of symbols) in a gibberish sequence

420 gibberish sequence generator code; together with data such as the character table and move frequency table, this code implements the gibberish generator

422 code for generating move frequency table

424 seed sequence used for generating move frequency table

502 frivolous content

504 profanity, i.e., profane content

506 gibberish

508 mismatched data category content (e.g., address vs. company name); not to be confused with mismatched data type content (e.g., float vs. Boolean)

510 out-of-range content, i.e., content that fails a bounds check

512 mismatched data type content, e.g., content representing a value in the wrong data type

600 another example data validation architecture

602 data quality and enrichment processing module

604 name validation processing module

606 profanity recognizer

608 machine learning technology(ies); learning is supervised unless stated otherwise

610 name classifier using machine learning technology(ies)

612 data category, as in expected data category of a data buffer, for example; may be implemented using semantic tags

614 code which orchestrates modules of multi-module system

616 database

618 CRM software

620 marketing or sales personnel

622 request for data validation

700 flowchart illustrating content characterization methods; 700 also designates these methods

702 receive data

704 generate predictor value, i.e., characterize received data

706 use regular expressions to perform or facilitate data characterization

708 use machine learning technology(ies) to perform or facilitate data characterization

710 identify (characterize) data as gibbersh

712 use named entity recognition technology (e.g., semantic tags) to perform or facilitate data characterization

714 link (associate) characterization (predictor value) to characterized data, e.g., by pairing them in a tuple or placing them together in a struct or pointing to one from the other

716 make data and its characterization available to a consumer, e.g., by transmitting them to the consumer, or setting a flag to indicate they are ready to be read by the consumer; alternatively, make only the data available for consumption because the characterization is implicit in that action, e.g., because data that is characterized as frivolous is not made available to the consumer

800 flowchart illustrating content characterizer creation methods; 800 also designates these methods

802 obtain a machine learning model, which may be untrained or partially trained, or may be fully trained in the sense it has been used in a production environment but is nonetheless subject to further training

804 train the model using training data 234

806 identify frivolous content, or at least link content to a predictor value which indicates the model's calculated estimate that the content is frivolous

808 use training data that is labeled as prohibited, e.g., as suspect or frivolous

810 data label indicating data is prohibited

812 use training data that is labeled as allowed, e.g., a valid personal name, valid family name, valid place name, valid company name

814 data label indicating data is allowed

816 use training data that is gibberish

818 training data that is gibberish

820 use n-grams in training data

822 n-grams of a specified kind, e.g., n-grams of strings that are profane, or n-grams of strings that are valid names

824 avoid use of certain n-grams in training data

826 configure a content characterizer, e.g., provide an API to submit data to the content characterizer to be characterized and to permit consumption of the characterization result by a consumer process

900 flowchart illustrating various methods; 900 also designates these methods

902 embody content characterization rules, e.g., include code or data that guides characterization of submitted content as valid or invalid or likely valid as indicated by a predictor value in the probability range from zero to one

904 produce content characterization rules, e.g., by training a machine learning model to embody such rules

906 label training set data; may be done manually or automatically

908 origin of training set data, e.g., database, list of registered company names, or other source

910 clean training set data prior to exposing a model to the data

912 remove legal designations from training set data

914 legal designations such as indications of a company's legal entity status, e.g., “Inc.”, “Gmbh”, “LLC” and so on

916 apply content characterization rules to data to help characterize data

918 execute code

920 code generally

922 recognize an instance of a regular expression in a string

924 instance of a regular expression

926 use prohibition predictor values, e.g., compare them to a cutoff threshold to determine whether data is discarded as likely invalid or instead forwarded for further processing (further processing may be either within the characterizer system or in an external consumer such as a CRM system)

928 recognize a category for data (and implicitly, assign that category to the data by tag or otherwise) using named entity recognition

930 select a natural language model, e.g., by detecting words or n-grams that are strongly associated with the natural language of the model, or by an identifier associated with the web form or other source of the data

932 natural language, as opposed to programming language

934 use capitalization in characterization of data, e.g., capital letter(s) inside words strengthens likelihood word is gibberish, leading capital letter strengthens likelihood word is a proper noun such as a place name or person name or company name

936 capitalization

938 factor—some fact whose presences or absence influences the predictor value produced by a characterization system

940 generate a gibberish sequence

942 generate a move frequency table

944 select an initial symbol when generating gibberish

946 emit a symbol as the next (or first) symbol in a gibberish sequence, by appending or prepending or otherwise; also referred to as adding the symbol

948 choose a move to another location in a symbol table when generating gibberish

950 move to another location in a symbol table when generating gibberish

952 constrain length of gibberish sequence

954 use move frequency table when generating gibberish

956 label gibberish as prohibited

Operating Environments

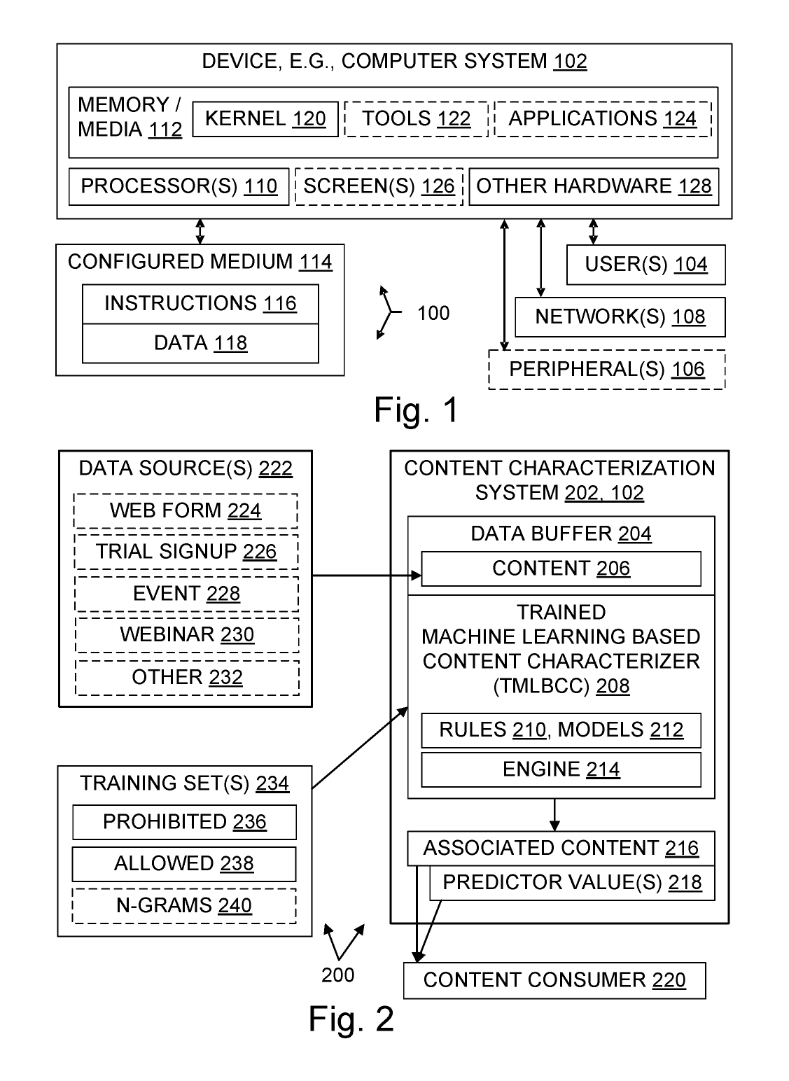

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud. An individual machine is a computer system, and a group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, software developers, engineers, and end-users are each a particular type of user 104. Automated agents, scripts, playback software, and the like acting on behalf of one or more people may also be users 104. Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a network 108 via network interface equipment, for example.

Each computer system 102 includes at least one processor 110. The computer system 102, like other suitable systems, also includes one or more computer-readable storage media 112. Media 112 may be of different physical types. The media 112 may be volatile memory, non-volatile memory, fixed in place media, removable media, magnetic media, optical media, solid-state media, and/or of other types of physical durable storage media (as opposed to merely a propagated signal). In particular, a configured medium 114 such as a portable (i.e., external) hard drive, CD, DVD, memory stick, or other removable non-volatile memory medium may become functionally a technological part of the computer system when inserted or otherwise installed, making its content accessible for interaction with and use by processor 110. The removable configured medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The medium 114 is configured with binary instructions 116 that are executable by a processor 110; “executable” is used in a broad sense herein to include machine code, interpretable code, bytecode, and/or code that runs on a virtual machine, for example. The medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system.

Although an embodiment may be described as being implemented as software instructions executed 918 by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, and/or GPUs), memory/storage media 112, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments peripherals 106 such as human user I/O devices (screen, keyboard, mouse, tablet, microphone, speaker, motion sensor, etc.) will be present in operable communication with one or more processors 110 and memory. Software processes may be users 104.

In some embodiments, the system includes multiple computers connected by a network 108. Networking interface equipment can provide access to networks 108, using components such as a packet-switched network interface card, a wireless transceiver, or a telephone network interface, for example, which may be present in a given computer system. However, an embodiment may also communicate technical data and/or technical instructions through direct memory access, removable nonvolatile media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

Content Characterization Architectures

FIGS. 2 through 6 illustrate example content characterization architectures 200, 600. The Figures also illustrate aspects of such architectures, such as some suitable components and the kinds of data that are processed or produced by the illustrated architectures.

As illustrated in FIG. 2, data from sources 222 such as web forms 224, trial signups 226, live events 228, webinars 230, and other sources 232 is fed through a buffer 204 into a content characterization system 202. The content characterization system 202 is a special-purpose computer system 102, which is configured to filter out, or at least detect, data 206 that is frivolous or otherwise deficient, before sending validated data on to a consumer process 220 such as a contacts database 616 or leads database 616 or CRM software 618 or personnel 620. The illustrated content characterization system 202 includes a trained machine learning based content characterizer (TMLBCC) 208. The TMLBCC has been trained through supervised machine learning by feeding it training data 234 that includes examples of prohibited content 236, and examples of allowed content 238. The examples may include n-grams 240, in addition to full words or phrases. The TMLBCC 208 embodies rules 210 as a result of the training; the rules are contained in a model 212 which interoperates with an engine 214. The TMLBCC 208 associates at least some portions 216 of the submitted content 206 with predictors 218 that indicate the extent to which the portion is considered to be prohibited or allowed.

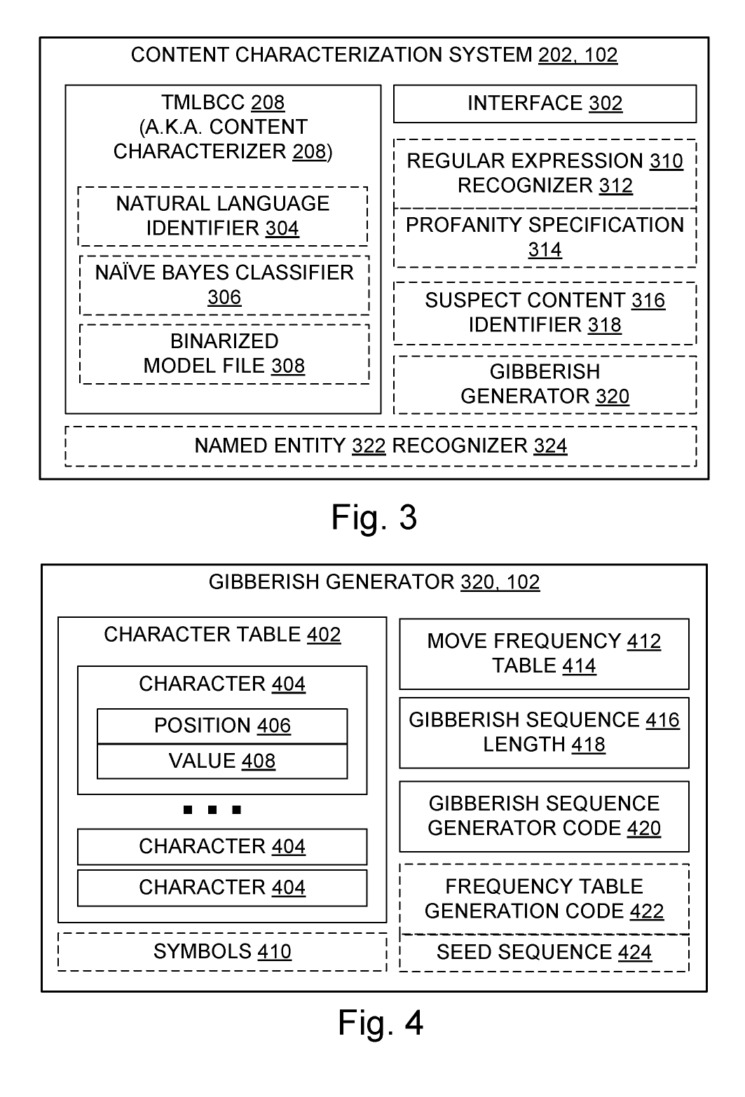

As illustrated in FIG. 3, a TMLBCC of a content characterization system 202, which is accessed via an interface 302, may include a naïve Bayes classifier 306. However, some embodiments use another classifier, such as a decision tree or another probabilistic classifier. The illustrated TMLBCC 208 also may include a natural language identifier 304, configured to identify the natural language of content that is expected through the interface, so that a corresponding model can be selected. A model trained on English data will not perform well on Chinese data, for instance, or vice versa, when identifying 318 suspect content 316 such as gibberish or profanity. As also shown, the model 212 used by a TMLBCC may be binarized, i.e., translated into a binary form and placed in one or more files 308. The binarized model is not directly modifiable for further training, but it operates more efficiently (gives results faster, may require less storage) than a trainable non-binary version of the model.

As also shown in FIG. 3, a content characterization system 202 may include a regular expression recognizer 312 which recognizes strings that match regular expressions 310 which are defined in a profanity specification 314. A gibberish generator 320 may be present, configured to provide gibberish for use as training data. As also shown, a content characterization system 202 may include a named entity recognizer 324 configured to recognize named entities 322 as belonging to a particular data category, such as the names of people, names of places, names of companies, and so on.

FIG. 4 further illustrates components of some gibberish generators 320. One component is a table 402 of characters 404 or other symbols 410, each symbol having a position 406 in the table and a value 408. A move frequency table 414 is also shown, specifying relative frequencies 412 of respective moves between positions 406 of the symbol table 402. Code 422 configured to generate the frequency table from a seed sequence 424 may also be present. Gibberish sequence generator code 420 uses the tables 402, 414 to generate gibberish sequences 416 under specified length 418 constraints.

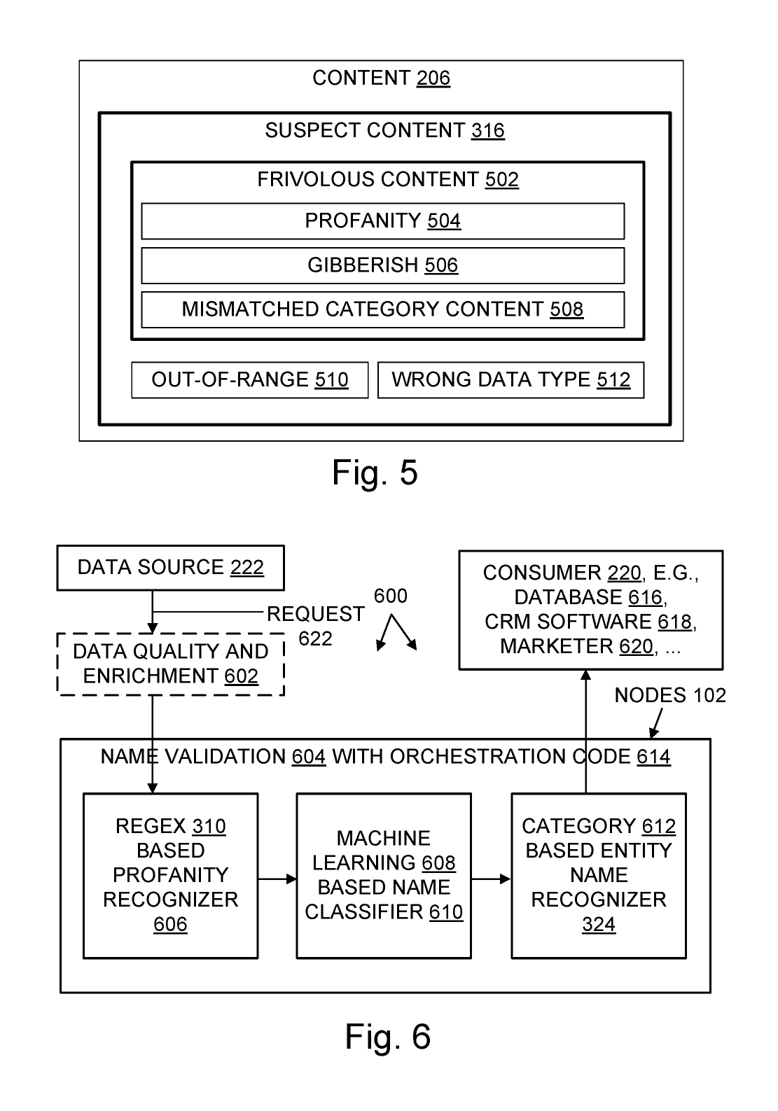

As illustrated in FIG. 5, the data 206 used or produced by the content characterization system 202 can be divided according to criteria set forth in definitions and explored by examples herein. Some data 206 submitted for characterization is suspect 316, for one or more reasons. Some data 510 violates a boundary constraint, e.g., twenty-five is out of bounds as a value for the number of hours traveled (on Earth) in one day. Some data 512 submitted has the wrong syntax for the expected data type, e.g., the float value 3.14159 is not an integer value.

Some data 502 of particular interest is denoted herein as “frivolous” data 502. Frivolous data includes profanity 504, gibberish 506, and data which is in the wrong semantic category as determined using a named entity recognizer 324. In a given implementation, mismatched category data 508 may include data that is valid in a different context than the context of its submission, e.g., “Iyer” is valid as a family name but is not valid as a country name. In a given implementation, gibberish is data 506 recognized as gibberish by a regular expression recognizer 312 or a TMLBCC 208. In a given implementation, profanity is data 504 recognized as profanity by a profanity specification, e.g., in a regular expression recognizer 312 or a TMLBCC 208. The foregoing are implementation-dependent variations on definitions given elsewhere herein; both are acceptable interpretations of the terminology.

FIG. 6 illustrates another content characterization architecture, in which data 206 from the sources 222 optionally goes through a data quality and enrichment component 602. This may include functionality to correct certain typographical errors, to enhance data by matching a partial submission with previously obtained information, and other operations. Regardless, names in the content 206 are submitted to a name validation component 604. Names in content 206 may include data submitted as a person's given name, their family name, an email address domain name, a street name, a city name, a province name, a country name, a company name, a sponsoring organization name, an agency name, an institution's name, or some other name.

The illustrated name validation component 604 includes three components: a profanity recognizer 606, a classifier 610 which employs machine learning technology 608, and a named entity recognizer 324 which assigns categories 612 such as city name, country name, given name, family name, place name, company name, organization name, and so on.

More About Systems

Examples are provided herein to help illustrate aspects of the technology, but the examples given within this document do not describe all of the possible embodiments. Embodiments are not limited to the specific implementations, arrangements, displays, features, approaches, or scenarios provided herein. A given embodiment may include additional or different technical features, mechanisms, sequences, or data structures, for instance, and may otherwise depart from the examples provided herein.

Some embodiments use or provide a content characterization system 202 including a processor 110; a digital memory 112 in operable communication with the processor; a data buffer 204 in the digital memory, the data buffer configured to accept string input; and a trained machine learning based content characterizer (TMLBCC) 208. The TMLBCC embodies rules 210 which perform content characterization and which were produced through supervised machine learning based upon a training set 234 that contains data 236 labeled as prohibited content and other data 238 labeled as allowed content. The TMLBCC is configured to upon execution with the processor perform a content characterization process which includes (a) reading 702 content from the data buffer, (b) applying 916 at least a subset of the rules for content characterization to thereby generate 704 a machine-learning-based prohibition predictor value 218 of the content, and (c) associating 714 an overall prohibition predictor value 218 with at least a portion of the content before the content is processed by a content consumer 220. The labels “(a)”, “(b)”, “(c)” here are meant to improve legibility and provide conceptual separability, not to imply or require a complete temporal separation or to impose more chronological order than is inherent. For instance, a piece of content is read before rules are applied to it, but additional content can be read before, or while, prohibition predictor association is performed with the first piece of content. The overall prohibition predictor value is in a range that is compatible with the range [0.0 . . . 1.0], and the overall prohibition predictor value is based at least in part on the machine-learning-based prohibition predictor value.

In some embodiments, the content characterization system 202 further includes a regular expression recognizer 606 which is configured to, upon execution 918 with the processor, recognize 922 an instance 924 of a regular expression 310 in the content from the data buffer, and associate 714 a regular-expression-based prohibition predictor value 218 with at least a portion of the content. The overall prohibition predictor value 218 is also based at least in part on the regular-expression-based prohibition predictor value 218.

In some embodiments, the content characterization system 202 further includes a named entity recognizer 324 which is configured to, upon execution 918 with the processor 110, recognize 928 in the content from the data buffer an entity 322 belonging to a data category 612, and compare 712 the data category of the recognized entity with an expected data category of the data buffer, and associate an entity-recognition-based prohibition predictor value with at least a portion of the content. The overall prohibition predictor value is also based at least in part on the entity-recognition-based prohibition predictor value.

In some embodiments, the content characterization system 202 further includes a gibberish generator 320. In some, the TMLBCC embodies at least one rule produced from training it with a training set that contains gibberish 416 generated 940 by the gibberish generator and labeled 956 as prohibited content.

In some embodiments, the TMLBCC 208 embodies one or more rules collectively produced 904 using a set A of words labeled as allowed content 238 plus n-grams 240 of words in set A labeled as allowed content 238 plus a set P of words in the training set labeled as prohibited content 236, and the training set is free of (avoids 824) n-grams of all words in set P labeled as prohibited content. This reduces profanity false positives.

In some embodiments, the TMLBCC 208 includes a naïve Bayes classifier 306.

In some embodiments, the TMLBCC 208 includes a natural language identifier 304 and selects 930 a natural language model based at least in part on content read from the data buffer. This conforms the model choice to the natural language 932 used in the submitted content.

In some embodiments, the TMLBCC 208 embodies at least one rule which uses 934 capitalization 936 as a factor 938 in generating the overall prohibition predictor value.

In some embodiments, the TMLBCC 208 includes at least one binarized model file 308 and is configured to perform the content characterization process without requiring any network transmission.

Methods

FIG. 8 illustrates a method 800 which is an example of methods performed or assisted by a content characterizer system 202. This method includes obtaining 802 a machine learning model, which may be accomplished by loading a commercially available ready-to-train model template, for instance, or loading a partially trained model. The method also trains 804 the model to identify 806 frivolous content by feeding the model (via an engine 214) training data 234 with examples of frivolous content 502. The training may use 808 data labeled 810 as prohibited (i.e., frivolous), may use 812 data labeled 814 as allowed (i.e., not frivolous), and may use 816 data 818 which is gibberish labeled 810 as frivolous. The training may use 820 or avoid using 824 n-grams of a particular kind 822, e.g., by using company name n-grams but not using profanity n-grams. The illustrated method also configures 826 the trained model which is configured for use in content characterization, e.g., by providing an interface between the data sources 222 and the TMLBCC 208.

In some embodiments, a content characterizer includes one or more of the modules 606, 610, 324, e.g., a machine learning module 610, a regular expressions module 606, and a named entity recognition module 324. A suspect content identifier can be a copy of the suspect content, or indexes into the data marking the start and end of the suspect content. “Suspect content” includes not only frivolous content but also content that is flagged as being the wrong data type or out of bounds.

In some embodiments, a content characterization process includes receiving 702, by a content characterizer, data 206 in a data buffer of an input interface; generating 704, by the content characterizer, a suspect content identifier 318 that identifies suspect content in the data from the data buffer, the suspect content including frivolous content; and linking 714, by the content characterizer, the suspect content identifier and a prohibition predictor value to the data from the data buffer before the input interface makes 716 the data from the data buffer available to a content consumer.

As discussed, profanity 504 is a special case of frivolous content 502. Some embodiments use regular expressions to define what is profane. In some embodiments, the content characterization process includes using 706 regular expression definitions to identify frivolous content that includes words or phrases designated in the content characterizer as profane.

Gibberish 506 is also a special case of frivolous content 502. In some embodiments, the content characterization process includes identifying 710 gibberish as frivolous content.

In some embodiments, the content characterization process includes using a trained machine learning based content characterizer (TMLBCC) 208 to identify frivolous content.

In some embodiments, the content characterization process includes using 712 named entity recognition to identify frivolous content, by identifying mismatched category content 508.

Some embodiments use only one module, some use two, and some use all three, namely, a regular expressions module, a machine learning module, and a named entity recognition module. The order in which the modules receive the data can be orchestrated. In some embodiments, the content characterization process includes using 706 regular expression definitions to identify frivolous content, and then using 708 a trained machine learning based content characterizer (TMLBCC) to identify additional frivolous content or as a basis to change at least one prohibition predictor value, and then using 712 named entity recognition to identify additional frivolous content or as a basis to change at least one prohibition predictor value.

Cleaning up contact information in marketing leads is an example use of some embodiments. In some embodiments, the content characterization process operates such that one or more instances of the process identify (e.g., perform step 922, 928, or 704, and step 714) frivolous content 502 in data which represents contact information for a person or entity.

Some methods involve using a trained model, while others involve training the model. One content characterizer creation process includes obtaining 802 a machine learning model; training 804 the machine learning model to identify frivolous content through supervised machine learning based at least in part on training set data which is gibberish and is labeled as prohibited; and also training 804 the machine learning model to identify frivolous content through supervised machine learning based at least in part on training set data which is labeled as allowed.

Some embodiments train without using n-grams derived from profanity but using full profanity example words. Some content characterizer creation processes train 804 the machine learning model using n-grams which are substrings of allowed input and labeled as allowed, and train 804 the machine learning model without using n-grams which are substrings of prohibited input, and train 804 the machine learning model using complete words which are labeled as allowed.

Some embodiments discard frivolous content. Some content characterizer creation processes configure 826 a content characterizer which uses the trained machine learning model to discard or nullify content that is identified by the content characterizer as being more likely than a determined threshold probability to be frivolous content.

FIG. 9 further illustrates some method embodiments in a general flowchart 900. Technical methods shown in the Figures or otherwise disclosed will be performed automatically, e.g., by content characterization system 202, unless otherwise indicated. Methods may also be performed in part automatically and in part manually to the extent action by a human administrator or other human person is implicated, e.g., a person may set thresholds that determine which content is discarded as frivolous. No method contemplated as innovative herein is entirely manual. In a given embodiment zero or more illustrated steps of a method may be repeated, perhaps with different parameters or data to operate on. Steps in an embodiment may also be done in a different order than the top-to-bottom order that is laid out in FIG. 9. Steps may be performed serially, in a partially overlapping manner, or fully in parallel. The order in which flowchart 900 is traversed to indicate the steps performed during a method may vary from one performance of the method to another performance of the method. The flowchart traversal order may also vary from one method embodiment to another method embodiment. Steps may also be omitted, combined, renamed, regrouped, or otherwise depart from the illustrated flow, provided that the method performed is operable and conforms to at least one claim. The steps shown are discussed throughout this disclosure, in the context of examples of their use.

Configured Media

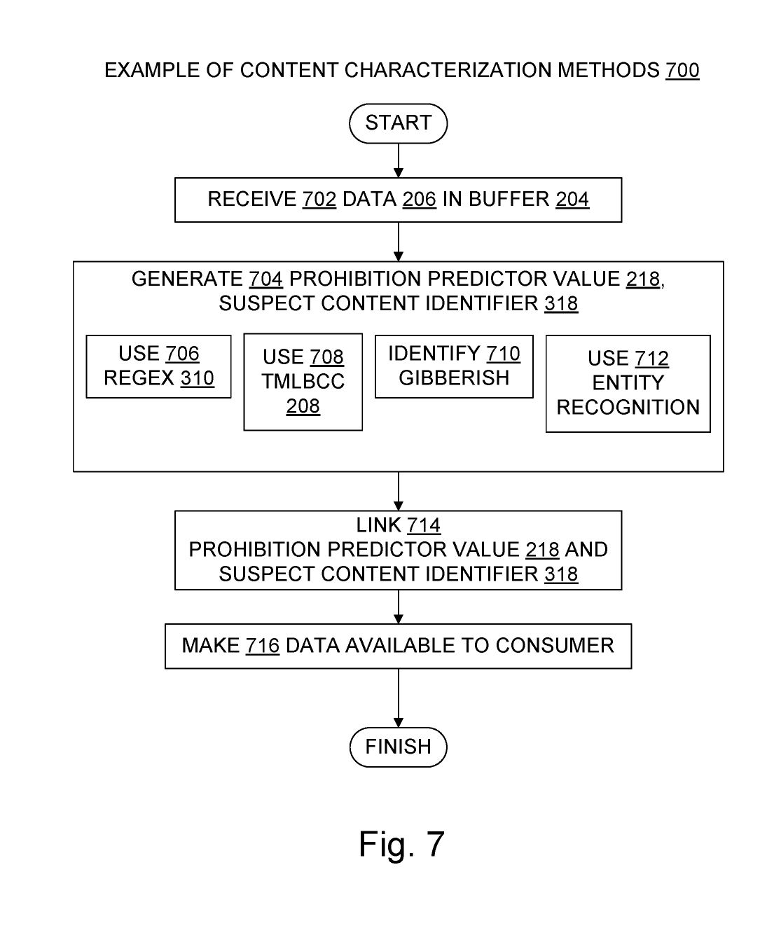

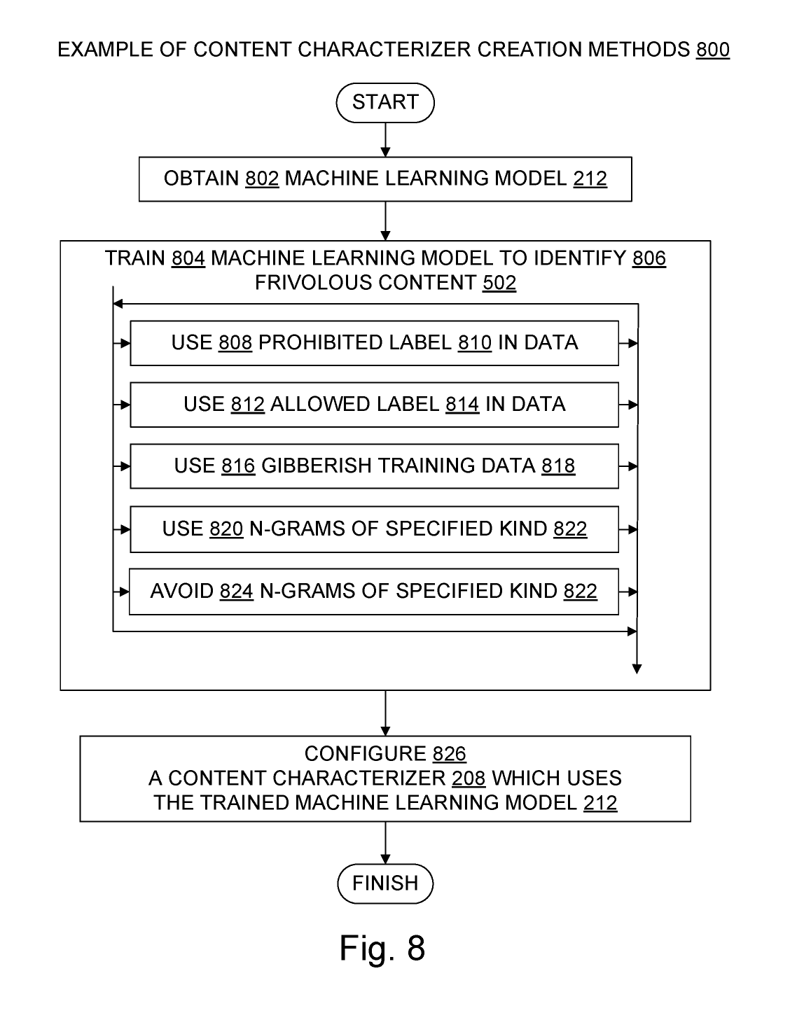

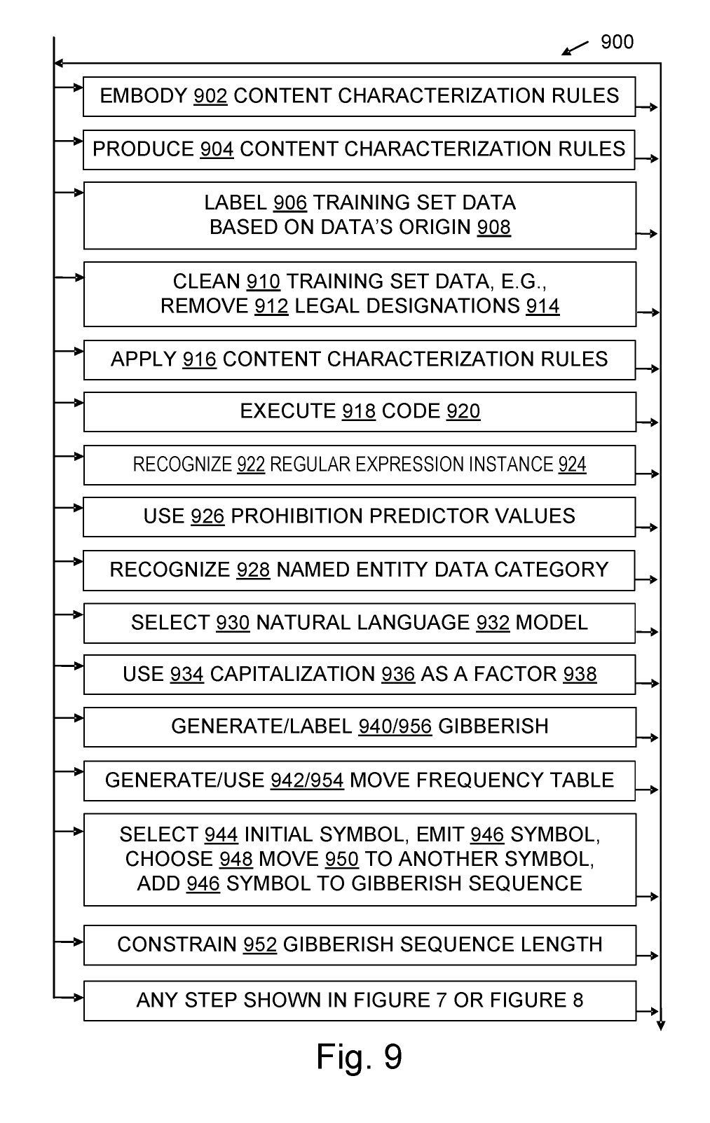

Some embodiments include a configured computer-readable storage medium 112. Medium 112 may include disks (magnetic, optical, or otherwise), RAM, EEPROMS or other ROMs, and/or other configurable memory, including in particular computer-readable media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as models 212, profanity regular expressions 310, gibberish sequences 416, classifier engines 214, named entity recognizers 324, name validation modules 604, and gibberish generators 320, in the form of data 118 and instructions 116, read from a removable medium 114 and/or another source such as a network connection, to form a configured medium. The configured medium 112 is capable of causing a computer system to perform technical process steps which enhance data processing by more efficiently and effectively identifying frivolous content 502 as disclosed herein. The Figures thus help illustrate configured storage media embodiments and process embodiments, as well as system and process embodiments. In particular, any of the process steps illustrated in FIG. 2, FIG. 6, FIG. 7, FIG. 8, FIG. 9, or otherwise taught herein, may be used to help configure a storage medium to form a configured medium embodiment.

Gibberish Generation

Some embodiments include or use gibberish generation functionality. Gibberish may be generated is various ways, e.g., by randomly choosing a character from a character set, appending it, and repeating the choosing and appending steps a random number of times. The length of gibberish may be constrained, e.g., to be less than the length allowed for a given data buffer. The length may also be determined by including a null or termination character in the character set, although this would tend to produce gibberish strings almost as long as the number of characters in the character set unless the null or termination character is more heavily weighted in the distribution of choices.

Some embodiments include or use gibberish generation functionality which is defined and operates as follows.

First, select a set of characters that will appear in the generated gibberish. For English gibberish, for example, one selection is the set of printable characters that can be generated from a conventional QWERTY keyboard. However, other character sets from other natural languages may also be used, and more generally, any set of symbols may be used, whether printable, audible, or otherwise distinguishable from one another. The symbols may appear in the chosen set with or without repetition, but unless otherwise indicated a set of unique (non-repeated) printable symbols is assumed.

Second, impose relative positions on the symbols. In the case of printable characters that can be generated from a conventional English QWERTY keyboard, for example, relative positions may be embodied in a table of the moves required to get from one key to another key. Shift keys may be represented as moves (e.g., move one right, move two down, shift to uppercase) or shifting may be represented by extending the symbolic keyboard to include, e.g., a grid of lowercase symbols next to a grid of shifted (including uppercase) symbols. On a given keyboard, moving from ‘q’ to can be accomplished by moving right four positions and moving up or down zero positions. Other sequences of moves could also be used, e.g., up one row, right two, down one row, right two, but for efficiency the shortest description (fewest operations) with no wraparound is assumed unless otherwise stated. Also, ambiguities caused by key offsets are resolved, e.g., by aligning keys horizontally and vertically in a grid to remove the ambiguities.

Third, assign a home position, also known as an origin, as the starting position when identifying the initial move in a given sequence of symbols. For example, the bottom left symbol in a grid may be the origin symbol, or the first character of an alphabet (e.g., lowercase ‘a’ in English) may be the origin symbol.

Fourth, obtain a seed sequence. The seed sequence, which is a sequence of characters drawn from the set of symbols discussed above, may be considered as the prime or leading example of the desired kind of gibberish. If N-symbol gibberish sequences are to be generated, then a prospective seed sequence either contains at least N symbols, or is repeated or otherwise reused to provide an N-symbol seed sequence. It will be apparent to one of skill in the art that the generated gibberish sequences are the same kind as the seed sequence, in that they share the same underlying set of symbols and the same frequency table. For instance, if one fourth of the seed sequence is 3-symbol-long substrings of a repeated symbol, then roughly a fourth of each generated gibberish sequence will also be 3-symbol-long substrings. An exact replication of the seed sequence frequencies in each generated gibberish sequence is not required.

Fifth, generate a move frequency table from the seed sequence. Identify the first symbol of the seed sequence as a relative move from the origin symbol, and add that move to a table of move instance counts which is initialized to all zeros; this is the move frequency table. Then identify the second symbol as a relative move from the first symbol, and add that to the table of move instance counts. Continue in this manner, identifying each subsequent symbol as a move from the prior symbol and incrementing the count of instances of that move in the move frequency table.

Sixth, generate a gibberish sequence. Select an initial symbol at random. Continue by selecting a move, based on another random value but weighted according to the move frequency table, and applying that move to the previous symbol to move to (and thus select) the next symbol, until a gibberish sequence of the desired length has been generated.

Gibberish generation functionalities are further illustrated by the following examples, as well as by other discussion and teachings provided herein which describe gibberish generation or its usage to accomplish data validation or to further other purposes.

Example 1. A gibberish generation system 320 including a processor 110, a memory 112, a character table 402 in the memory containing characters 404 from a character set which have positions 406 in the table relative to one another, a move frequency table 414 in the memory indicating relative frequencies 412 of moves from a given position in the character table to another position in the character table, a gibberish sequence length 418 which is a positive integer value, and a generator code 420 which upon execution 918 by the processor generates 940 a gibberish sequence 416 of gibberish sequence length as a sequence of characters that are chosen for inclusion in the sequence by moves in the character table based on the move frequency table.

Example 2. The gibberish generation system 320 of example 1, wherein the characters 404 are Unicode characters.

Example 3. The gibberish generation system 320 of example 1, wherein the characters 404 include characters that appear on a computing device 102 keyboard 106 which is a physical keyboard or a virtual (software graphical user interface) keyboard.

Example 4. The gibberish generation system 320 of example 1, wherein the gibberish sequence length 418 satisfies 952 at least one of the following conditions: it is in the range of four characters to twenty characters, it is in the range of five characters to ten characters, it is in the range of eight characters to thirty characters, it is less than one hundred characters, it is at least twenty characters, it is at least fifty characters, it does not exceed a maximum number of characters permitted for any valid data entry into a predetermined buffer of a web form or other user interface.

Example 5. The gibberish generation system 320 of example 1, further including frequency table generation software 422 which upon execution with the processor generates 942 the move frequency table 414 from a seed sequence 424.

Example 6. The gibberish generation system 320 of example 1, further including any one or more components, data structures, or functionalities described anywhere in the present disclosure, including for example machine learning items, named entity recognition items, and regular expression items.

Example 7. A gibberish generation process including selecting 944 an initial symbol at random from a table 402 of symbols 410 in which symbols have positions relative to one another and emitting 946 that symbol as part of a gibberish sequence, choosing 948 a move 950 within the table to another location and appending 946 the symbol at that location to the gibberish sequence or otherwise adding it to the gibberish sequence, and repeating the steps of choosing a move and appending the symbol at the location indicated by the move until a gibberish sequence of a specified length 418 has been generated 940.

Example 8. The gibberish generation process of example 7, wherein choosing 948 a move chooses a move based on a value that is weighted according to a move frequency table 414.

Example 9. The gibberish generation process of example 7, wherein the process generates 940 Unicode gibberish one character at a time, and the table 402 includes at least some symbols which each include a single Unicode character.

Example 10. The gibberish generation process of example 7, wherein the process generates 940 Unicode gibberish multiple characters at a time, and the table 402 includes at least some symbols which each include multiple characters, namely, gibberish n-grams.

Example 11. The gibberish generation process of example 7, wherein choosing 948 a move within the table is based on a move frequency table 414.

Example 12. The gibberish generation process of example 11, further including generating 942 the move frequency table from a seed sequence.

Example 13. The gibberish generation process of example 12, wherein the seed sequence 424 contains substrings of length N of a repeated symbol denoted here as S, and the generated gibberish sequence also contains at least one substring of length N of either the same symbol S repeated or of another symbol repeated.

Example 14. The gibberish generation process of example 7, further including any one or more steps, actions, or other operations described anywhere in the present disclosure.

Some Additional Combinations and Variations

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the medium combinations and variants describe above.

As noted, frivolous content occurs in different fields of a form submission. Some embodiments focus on detecting frivolous content in company name or person name fields. In these fields, frivolous content 502 is in the form of profanity 504, keyboard gibberish 506, and unrelated content 508 (to wit, words or phrases that don't relate to a company name or person name). One implementation includes three modules 604 to detect this frivolous content and has a rule based orchestration engine 614 to chain these modules together. The first module 606 contains regular expression based profanity rules 310. The second module 610 has a naïve Bayes machine-learning model 212 that is trained on good content 238 as well as frivolous content 236 (keyboard gibberish generated 940 from 3-7 letter character n-grams 240, 238 and profanity 504, 236). The third module 324 uses entity recognition to tag 928 the input as either a person name, company name, address, phone, or other entity 322.

This implementation provides the ability to detect the quality of company name and person name submissions by determining profanity, junk and gibberish across various languages 932. In doing so, this implementation uses a hybrid algorithm of static rule based patterns, machine learning, and entity recognition, with and orchestration between these modules for detection of frivolous data. Instead of adding profanity words and n-grams as part of the frivolous dataset 234 used for training the machine learning model, this implementation controls and reduces false positives by not using character level n-grams for profanity content in the training set. This implementation also provided functionality 320, 420 for generating 940 keyboard gibberish 416, 506 for training 804 the machine learning module.

To further illustrate teachings provided herein, the following detailed discussion is included. Corresponding details are not necessarily required in a particular embodiment, and are not necessarily required for an understanding of every embodiment.

Orchestration of modules. Consider a company name being input into the system (person name processing is similar).

Each of the three modules implements an input rule IsFrivolousCompany=blank or IsFrivolousCompany=false before they start processing the input. By default, IsFrivolousCompany is blank.

The input company name goes through the first module 606 to detect any static profanity. The module 606 marks a field IsFrivolousCompany to true or false based on regex 310 profanity comparison. These regex are pre-determined and stored in a SQL table or other data storage structure. If IsFrivolousCompany is true, the other two modules are skipped by the orchestration engine 614 and that input company name is marked as frivolous when returned by the service 604.

If the field IsFrivolousCompany is false, the company name goes to the second module 610 to detect any other forms of profanity or keyboard gibberish. The same field IsFrivolousCompany is marked as true or marked false by the second module. If IsFrivolousCompany=true, the third module 324 processing is skipped and the input company data is marked as frivolous when returned by the service 604. More details about the machine learning module 610 can be found elsewhere herein.

If the field IsFrivolousCompany is false, the third entity recognition module 324 uses an SDK to determine if the input contains any entities 322 such as person name, event, and so on. If the entire content of the input is marked as company name, the field IsFrivolousCompany is set to true and the input company is marked as frivolous when returned by the service 604.

After processing, if the field IsFrivolousCompany=false, then the input company name is marked as not frivolous when returned by the service 604.

Some examples of static profanity 504 patterns implemented in the first module 606 profanity specification 314 includes %BLOW%JOB%, %BASTARD%, %ASSHOLE%.

Some examples of gibberish 506 effectively detected with the second module naïve Bayes machine learning model 212 includes fdsfds.fsd, FRTFHJ, gfjhvuvf, sfsgfgh.

Some examples of unrelated content 508 detected by the named entity recognition module 324 includes Barack Obama, Donald Trump (tagged as person names), iPod, iPhone (tagged as consumer goods; marks of Apple Inc.), concert, piano recital (tagged as events, work of art) in company name fields. Names such as Donald Trump do not get tagged by the machine learning model of the second module as frivolous since valid company names exists in the training set such as Trump Enterprises, Trump Organization, etc. But an entity recognition module identifies these as frivolous submissions for person names. The same is true for some other person names, since many companies are named after people names that the machine learning model tags as good company names.

A more detailed description of the particular naïve Bayes based machine learning model of the second module in this implementation follows.

The machine learning model uses training data 234 containing about 1.5 million real company names and about 208,312 fake (profanity and gibberish) company names. These numbers are merely one of many possible examples of an implementation at production scale; a given facility, organization, manager, administrator, or other authority will have its own criteria for distinguishing production use of a machine learning model from non-production use. Other implementations according to teachings herein may have fewer or more training data items than the specific examples provided herein. Also, in a given implementation, the ratio of true/positive/valid/correct (descriptors may vary) data from false/negative/invalid/incorrect data may differ. In particular, training data is not necessarily skewed toward positive cases as it is in this example. Before being used to train 804 the model, commonly used company suffixes 914 such as Private, Ltd., and Inc. were removed 912 from the data.

The team used software to generate n-grams 240 (combinations of contiguous letters) of three to seven characters, and to calculate probabilities that each n-gram belongs to the real name or fake name dataset in the model. For example, n-grams that show three sequenced letters of the name “Microsoft” would look like “Mic,” “icr”, “cro”, and so on. The training process computes how often particular n-grams occur in real or fake company names and stores the computation in the model 212.

This implementation included four virtual machines 102 that run Microsoft Machine Learning Server software. One virtual machine serves as a web node and three serve as compute nodes. There are more compute nodes to support scaling to handle the volume of requests 622 experienced. The architecture 600 implemented with virtual machines provides the ability to scale up or down by adding or removing compute nodes as needed based on the volume of requests. The data submitter calls a web API 302 hosted on the web node, with the submitted company name as input 206.

The web API calls a scoring function 214 on the compute node. This scoring function generates n-grams from the input company name and calculates the frequencies of these n-grams in the real or fake training dataset.

To determine whether the input company name is real or fake, the predict function in an R programming environment uses these calculated n-gram frequencies stored in the model, along with the naïve Bayes rule 210. The R programming environment is merely one example; other implementations may use a Python™ programming environment or one or more other programming languages (Python is a mark of the Python Software Foundation).

To summarize, the scoring function that's used during prediction generates the n-grams. It uses the frequencies of each n-gram in the real or fake name dataset that's stored in the model to compute the probability of the company name belonging to the real or fake name dataset. Then it uses these computed probabilities to determine if the company name is fake.

In this implementation, the machine-learning module uses about 1.5 million good names and about 208K frivolous names (profanity and gibberish). This module is retrained 804 based on a feedback loop in order to reduce false positives and false negatives (retraining and tuning are examples of training 804). To control the false positives, as an optimization, training avoids 824 training profanity content as part of frivolous names on character n-grams and includes only the whole words for profanity in the model. Usage of profanity in the frivolous content of the model and not using n-grams derived from the profane content helps limit false positives, namely, correct company names being marked as frivolous. Usage of character n-grams for profanity increased the false positives.

The machine learning model is trained with profanity data across geographies and keyboard gibberish generated 940 at random by a program. In this way, the system 202 can determine quality of lead submissions across multiple languages 932.

When generating keyboard gibberish for training the model, this implementation uses an algorithm that randomly selects characters from a-z and A-Z to generate 940 a sequence 416 of a desired length 418.

Usage of quality determined by the modules. To determine quality of the form submission 206, code 614 could come up with a combined quality score that uses two fields output by the approach described above, IsFrivolousCompanyName and IsFrivolousPersonName, and two other fields determined by external modules, IsFrivolousPhone, IsFrivolousEmail. One implementation uses external SDKs and APIs to determine whether the phone number and email are valid or not.

As an example, the following could be weights 938 for each field score:
IsFrivolousPhone: 0.3
IsFrivolousEmail: 0.3
IsEnriched: 0.2
IsFrivolousCompanyName: 0.1
IsFrivolousName: 0.1

All the scores add up to a quality score of one. IsFrivolousPhone and IsFrivolousEmail have higher weights since they determine contact ability of the lead. The IsEnriched field could help provide information on company size or company segment. The higher the score, the better is the lead or other form submission quality and the more likely the submission will be useful to the data recipient if routed to the systems 220 downstream.

Some conclusions. The approach described above provided an algorithm for detecting the quality of company name and person name data by determining profanity, junk, and gibberish across various languages. This was done with an innovative hybrid algorithm that utilized static rule based patterns, machine learning, and entity recognition, with orchestration between these modules for frivolous detection. Efficiency was increased by adding profanity words as part of the frivolous dataset used for training the machine learning model and controlling the false positives by not using character level n-gram for profanity content in the TMLBCC. Automated generation of keyboard gibberish also provided data 234 for training the machine learning module.

Contact Information Case Study

To further illustrate teachings herein, a case study is now discussed. This discussion pertains to particular aspects of a particular implementation in a particular operating environment to operate on particular kinds of data, and the teachings herein will be understood to extend beyond such particularities, which are also not necessarily required in any given embodiment. In particular, the case study is not meant to limit use of the technology described herein to use by Microsoft, although Microsoft is in the example, and the case study is not meant to limit use of the technology described herein to the particular use of validating leads. For instance, the technology could be used to clean or validate remarks and other content submitted through feedback mechanisms, job application mechanisms, review mechanisms, suggestion mechanisms, comment mechanisms, and in many other situations. The mechanisms through which content is obtained may include web forms, text input boxes, files, data streams, XML structures, and other mechanisms for obtaining textual content.

Microsoft collects contact information for sales and marketing leads when people request information or access gated content with an online form. One marketing automation system collects leads through avenues 222 such as trial products, services, and subscriptions, events like conferences, webinars, and training sessions, and content downloads. When people sign up for a trial product, send related email, or download content, they may become leads. The names gathered this way, which can be a company name or a personal name, become records in the marketing automation system 220. Then marketers and sellers follow up with the leads in an effort to turn them into customers by selling them a product, service, or subscription, based on the interest they expressed when they provided the contact information.

However, when people sign up via online forms, they sometimes give a fake name, fake company name, fake email, or fake phone number. They may submit randomly typed characters (keyboard gibberish 506) or use profanity 504. Or, they may accidentally make a small typographical error, but otherwise the name is real, so the lead should not be classified as junk. Fake lead names result in lost productivity; fake names can waste an enormous amount of time because sellers rely on accurate information to follow up with sincerely interested leads. Fake lead names also result in lost revenue opportunities. Among thousands of discarded fake lead names, there could be lost a legitimate opportunity from someone who is sincerely interested in learning more about Microsoft's products and services.

A Microsoft team was able to improve data 206 quality with machine learning technology. Each day, thousands of people sign up as leads using thousands of web forms. But in a given month, many of the lead names (whether a company or a person) are fake. To improve data quality and determine if names are real or fake, the team built and operated internally a solution which uses machine learning. This solution uses Microsoft Machine Learning Server (previously Microsoft R Server), and a data quality service that integrates machine learning models with the contact information data source. When a company name enters the marketing system as part of contact information provided by a potential lead, the system calls the data quality service 604, which immediately checks whether the company name given is a fake name.

Machine learning has reduced the number of fake company names that enter the marketing system, and done so at scale. The implemented solution has prevented thousands of useless names from being routed 716 to marketers and sellers. Filtering out junk leads has made the marketing and sales teams more efficient, allowing them to focus on real leads and help customers better.

Operationalizing the model, at scale, was a challenge. Microsoft needed a scalable way to eliminate fake names across millions of records and to build and operationalize the machine learning model, to obtain a systematic, automated approach with measurable gains. The team responsible chose Microsoft Machine Learning Server software, in part, because it can handle large datasets, which enabled the team to train and score the model. Also, Machine Learning Server technology has the computing power needed. The team was also able to control scaling of the model and operationalization for high-volume business requests 622. Access was based on user name and password, which were securely stored in Microsoft's Azure® Key Vault (mark of Microsoft Corporation). Machine Learning Server also helped expose the model 212 as a secure API that can be integrated with other systems and improved separately.

Implementing a machine learning-based approach may involve moving from a static rules-based model to a dynamic paradigm of machine learning. A data validation system 202 can make automated decisions in some cases, such as identifying and weeding out some fake names, based on static rules that cover some common scenarios. As new scenarios occur, new static rules are written to handle them, but this approach has limitations as the complexity of the rules increases beyond manageability, or the rules fail to address complexity in the input, or both. It is simply not practical, for example, to identify all gibberish data submissions and separate them from valid data using only static rules based on regular expressions 310.

Regular expression-based detection of profanity also yielded false positives, e.g., “Parikshit” is a legitimate Indian personal name, in use as early as the 9^{th}-12^{th} centuries BCE, but it also contains a commonly used profane synonym for feces, as a four character substring. Similarly, “Cock” is easily detected as profanity using a regular expression. But Wikipedia recognizes “Cock” not only as a vulgarity but also as a non-profane surname (family name) and as part of several non-profane place names.

A more flexible and dynamic approach is to use machine learning. Algorithms are used to train the machine learning model to make intelligent (i.e., useful) predictions. A static rules-based model can make it hard to detect varying types of keyboard gibberish (like “akljfalkdjg”). With only static rules, people who are given the contact information must waste time sorting through fake leads and deciphering misleading or confusing information. In contrast, machine learning algorithms help build and train 804 a model by labeling and classifying data at the beginning of the processing of leads. As data 206 enters the model, the algorithm categorizes the data correctly and automatically, saving the human sellers valuable time, and conserving the computing resources they would have directed toward the processing of invalid leads.

Realizing how machine learning could help, the team used a naïve Bayes classifier algorithm 210, 214 to categorize names as real/fake. The algorithm was influenced by how LinkedIn Corporation detects spam names in their social networks. After opting to use a machine learning model, the team incorporated several technologies into its solution. One is the programming language R and the naïve Bayes classifier algorithm for training and building the model, chosen in part by analogy to the approach that LinkedIn Corporation uses to detect spam names. The machine learning technology employed uses a character n-gram based naïve Bayes model that takes into account the order of vowels and good character sequences in a names dataset. The machine learning component 208, 610 is supplemented by a regular expression component 606, and also supplemented by an entity recognition component 324 which identifies entity mismatches, including frivolous company names, such as personal names that were entered into a company name field or an address field.

One technological component is the Machine Learning Server product with machine learning, R, and artificial intelligence (AI) capabilities which helped build and operationalize the model. Another technological component is the data quality service, which integrates with the machine learning models to determine if a name is fake. While the approach taken in this project has focused on fake company names, frivolous input detection can be implemented similarly for fake person names.

The architecture built for this project includes a Global Demand Center which feeds data submissions 206 to a Lead Data Quality and Enrichment Service (“LDQE Service”) 202. The data input arises from Events, Webinars, Forms, and Trial Signups. The LDQE Service 202 processes the data and sends the Global Demand Center 220 Enriched High Quality Leads, which are then scored, routed, and prioritized for transmission to Customer Relationship Management end users such as Field Marketers Corporate Marketers and Sellers who can convert leads into sales opportunities and mutually beneficial commercial relationships.

The LDQE Service as implemented uses functionalities of Azure® Cosmos Database, SQL Azure, Azure API Management, Azure Service Fabric, Microsoft Machine Learning Server, Azure Function, Fuzzy Matching, and Azure Key Vault (mark of Microsoft Corporation). The LDQE Service provides Company Validation, Person Name Validation, Email Validation, and Phone Validation. Gibberish 506 detection and profanity 504 detection can also be performed for email and phone data, but company names and person names are used here as the primary examples because there were fewer regular expression or syntax-based checks available on company and person names. Email addresses and telephone numbers have narrower syntax than company and person names, e.g., domain name validity can be checked using the Domain Name System, and valid telephone numbers allow only a few non-numeric characters and no alphabetic characters in many cases.

The LDQE Service Company Validation and Person Name Validation components included three staged modules which process input in turn: a Static Rules Provider 606, followed by a Machine Learning-based Provider 610, which was followed by an Entity Recognition Provider 324. The Static Rules Provider included a service which communicated with profanity regular expressions 310 in a Microsoft SQL Server® environment (mark of Microsoft Corporation). A SQL stored procedure was used to generate n-grams, frequencies and probabilities, which were saved in a table used as a model. The Machine Learning-based Provider 610 included a Web Node 102 which communicated with three Compute Nodes 102. Each Compute Node included an R naïve Bayes model 212 corresponding to the relevant data, e.g., company names. In particular, the Web Node configuration in this implementation included one Data Science virtual machine running Microsoft ML Server with web node configuration enabled and 2 core 14 GB, and the implementation's compute node configuration included three Data Science virtual machines running Microsoft ML Server with compute node configuration enabled and 8 core 56 GB. In the implementation, the model was converted to binary, thereby providing quicker access. The Entity Recognition Provider included a service which communicated with an Entity Recognition SDK/API.

The frivolous name machine learning (ML) model was trained 804 offline, assessed for accuracy, retrained as needed, and binarized 308 when it provided acceptable accuracy in predicting whether input data was gibberish or profanity or valid. For person names, the production ML model first name (given name) training set 234 included over 1 million n-grams 240, the production last name (family name) training set 234 included over 2 million n-grams 240, and the production training data 234 included almost 3 million examples, of which about 2.5 million were invalid names 236 and the remainder were valid names 238. The response time for a given name validity prediction was on the order of milliseconds. As noted above, specific numbers such as these are merely examples, not limitations, and the ratio of different kinds of data (e.g., first names and last names, or invalid names and valid names) may differ from one implementation to another. Model accuracy was assessed using manual inspections, confusion matrixes, and test cases, and the model was tuned 804 as needed with additional or different training data until the accuracy met acceptability thresholds.

The naïve Bayes letter n-gram frivolous company name model in this implementation was built in the R environment, and exposed via an API through operationalization capabilities of Microsoft Machine Learning Server. In operation, the model improves data quality by detecting gibberish 506 and profanity 504 in company names. The technology could also be implemented to detect profanity or gibberish in person names, product names, addresses, remarks, comments, reviews, and other textual data submissions 206. The technology could also be implemented to detect profanity only, or to detect gibberish only. The definition of profanity 504 implemented could be relatively narrow, to more closely match lay use of the term, e.g., profanity means words which are flagged as vulgar or deemed not proper for use in polite society or with children. Alternatively, the definition 314 of profanity 504 as implemented could be broadened to include any input that is forbidden for reasons beyond a simple mismatch in the primitive data types or being out-of-range. Under this broader definition, the presence of SQL code or reserved words of a programming language where a company name is expected would be a form of profanity because it is forbidden; this broader definition treats profanity as including SQL injection cyberattacks. Unless otherwise indicated, the narrower definition of profanity applies herein.

The team designed the overall architecture and process of this implementation to work as follows. Leads 206 entered the data quality and enrichment service, where the solution did fake-name detection, data matching, validation, and enrichment. The team combined these data activities using a 590-megabyte model 212. The training data 234 consisted of about 1.5 million real company names and about 208,000 fake (profanity and gibberish) company names. Before training 804 the model, the team removed 912 commonly used company suffixes such as “Private”, “Ltd.”, and “Inc.”, based on static rules.

As training data, the team generated 904 (by using software) n-grams, which are combinations of contiguous letters, three to seven characters long in the project (other ranges may be used in other implementations). The software also calculated 904 the respective probability 210 that each n-gram belongs to the real/fake name dataset in the model. For example, an n-gram that shows three sequenced letters of the name “Microsoft” would look like “Mic,” “icr” “cro” and so on. The training process computed how often the n-grams occur in real/fake company names and stored 902 the computation in the model 212.

The implementation has four virtual machines 102 that run Machine Learning Server software. One serves as an interface web node and three serve as compute nodes. This implementation has more than one compute node so that it can scale to handle the volume of requests it receives. The architecture gives the implementation the ability to scale up or down by adding/removing compute nodes as needed, based on the volume of requests 622. The provider calls a web API hosted on the web node, with company name as input.

The web API calls the scoring function 214 on the compute node. This scoring function generates n-grams from the input company name and calculates the frequencies of these n-grams in the real/fake training dataset. To determine whether the input company name is real or fake, the predict function in R uses the calculated n-gram frequencies stored in the model, along with the naïve Bayes rule.

To summarize, the scoring function 214 that is used during frivolousness prediction generates the n-grams. It uses the frequencies 210 of each n-gram in the real/fake name dataset that is stored in the model to compute the probability of the company name belonging to the real/fake name dataset. Then, it uses these computed probabilities to determine 704, 926 if the company name is fake, based on embedded or configurable probability thresholds.

Several observations are offered now, based on what the team learned.

First, good training and test data is important. Much of the work done involved labeling 810, 814 test data, analyzing how naïve Bayes 306, 214 performed compared to rxLogisticRegression and rxFastTrees algorithms 214, determining how accurate the model was, and updating the model as desired.

Second, when designing a supervised learning machine learning model, it is important to identify how to effectively label the raw data. Unlabeled data has no information to explain or categorize it. In this project, the team labeled the names as fake/real and applied the machine learning model. This model 212 takes new, unlabeled data and predicts 218 a likely label for it.

Third, even with a machine learning solution, there is a risk of having false positives and false negatives, so designated personnel may need to keep analyzing predictions and retraining 804 the model. Crowdsourcing may be an effective way to analyze whether the predictions from the model are correct.

Fourth, adding n-grams for profanity in the training dataset led to significant false positives. For training the model, it may be better to use 820 n-grams for gibberish data only. Use only the entire profane words, avoiding 824 the use of n-grams for profanity. To reduce false negatives, an implementation could also use name entity recognition.

Fifth, names can be better classified when the classification takes into consideration as a factor 938 whether the n-gram is on the start or on the end. For example, it is more probable that a valid name starts with “Sa” or “\hat{ }Sa” (\hat{ } indicates whitespace) than it is that the interior of the name contains “Sa” (case sensitive 936).

Sixth, better results are obtained by separating a person's first name (given name) and last name (family name) into two different models 212 instead of using just one model for both. As used herein, the “first name” is the given name and the “last name” is the family name, so in practice and depending on local conventions and practices, the family name may actually precede the given name in the input data.

Seventh, false positives from a static module, e.g., a regular expression module 606, can be corrected by a machine learning model. For instance, a regular expression module may treat “none” (or case insensitive variations of it) as invalid for a company name, but some legitimate company names contain a “none” substring (which matches an n-gram), e.g., Brunone Innovation and Fourteenone Management GmbH.

Although this particular implementation used the Machine Learning Server product, other technologies may also be used, from Microsoft or from other vendors. Some possibilities include SQL Server® 2017 Machine Learning Services (previously SQL Server 2016 R Services), and Azure® Machine Learning Studio (marks of Microsoft Corporation). The same is true of other Microsoft products identified herein; embodiments are not limited to implementations that use these specific products, or even to implementations that use Microsoft products.

Here are some additional considerations when deciding how to create and operationalize a model.

If there is no dependence on SQL Server® software for a model, Machine Learning Server can be used, with libraries in R and Python to build the model, and then one can operationalize R and Python models. This option allows one to scale out as needed and lets one control the version of R packages used for modeling.

If training data is in SQL Server® storage and one wants to build a model that is close to that training data, SQL Server 2017 Machine Learning Services works well. But there are dependencies on SQL Server® software and limits on model size.

If the model is relatively simple, one could build it in a SQL Server® environment as a stored procedure without using libraries. This option works well for simpler models that aren't hard to code. It can provide good accuracy and use fewer resources, which saves money.

If one is doing experiments and wants quick learning, Azure® Machine Learning Studio is a fine choice. As the training dataset grows and one wants to scale models for high-volume requests, consider Machine Learning Server and SQL Server® 2017 Machine Learning Services.

Some of the roadblocks the team faced in this project include the following.

Having good training data. High-quality training data began with a collection 908 of company names that are clearly classified as real or fake, ideally, from companies around the world. The team fed that information into a model for it to start learning the patterns of real or fake company names. It takes a while to build and refine this data, and it's an iterative process.

Identifying and manually labeling the training and test dataset. The team manually labeled thousands of records as real or fake, which took a lot of time and effort. Instead, another project might take advantage of crowdsourcing services if possible, or automated labeling, or use prelabeled data 908, to avoid manual labeling by the team. With crowdsourcing services, one submits company names through a secure API and a human says if the company name is real or fake. An alternative would be to pull company names only from databases 908 that contain names already vetted, such as trademark databases, securities reports or other regulatory submissions, stock exchange listings, and so on.

Deciding which product to use for operationalizing the model. The team tried different technologies, but found computing limitations and versioning dependencies between the R Naive Bayes package it used and what was available in Azure® Machine Learning Studio at the time. The team chose Machine Learning Server because it addressed those issues, had the computing power desired, and helped the team scale out the model.

Configuring load balance. If the Machine Learning Server web node gets lots of requests, it randomly chooses which of the three compute nodes to send the request to. This can result in one node being overloaded while another is underutilized. One response is to use a round-robin approach, where all nodes are used equally to better distribute the load. This can be achieved by using an Azure® load balancer in between the web and compute node.

Measurable benefits have been obtained. With the machine learning model, the system tags about 5 to 9 percent more fake records than the static model. This means the system prevented 5 to 9 percent more fake names from going to marketers and sellers. Over time, this represents a vast number of fake names that the sellers do not have to sort through manually. As a result, marketer and seller productivity is enhanced, storage requirements for leads are reduced, and computational resources that would have been spent on email or other outreach to spurious leads have been conserved. The system also captured more gibberish data and detected most profanities, with fewer fake positives and fake negatives. The implementation has a high degree of accuracy, with an error rate of +/−0.2 percent. The time to respond to requests has also improved. With 10,000 data classifications of real/fake in 16 minutes and 200,000 classifications in 3 hours 13 minutes, the data quality service meets service level agreements for performance and response time. It may be possible to further improve response time by optimizing the algorithm's implementation in Python.

Conclusion

Although particular embodiments are expressly illustrated and described herein as processes, as configured media, or as systems, it will be appreciated that discussion of one type of embodiment also generally extends to other embodiment types. For instance, the descriptions of processes in connection with FIGS. 7-9 also help describe configured media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific APIs, specific fields, and specific sample programs, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims and the abstract, as filed, are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A content characterization system comprising:
a processor;
a digital memory in operable communication with the processor;
a data buffer in the digital memory, the data buffer configured to accept string input;
a trained machine learning based content characterizer (TMLBCC) which embodies a content characterization rule which is a probabilistic classifier in a supervised machine learning model comprising training set data labeled as prohibited content and also comprising other training set data labeled as allowed content, the TMLBCC configured to upon execution with the processor perform a content characterization process which includes reading content from the data buffer, applying the content characterization rule to at least a portion of the read content to thereby generate a machine-learning-based prohibition predictor value of the portion of content, and associating an overall prohibition predictor value with at least the portion of the content, the overall prohibition predictor value being in a range that is compatible with the range [0.0 . . . 1.0], the overall prohibition predictor value based at least in part on the machine-learning-based prohibition predictor value.

2. The content characterization system of claim 1, further comprising a regular expression recognizer which is configured to, upon execution with the processor, recognize an instance of a regular expression in the content from the data buffer, and associate a regular-expression-based prohibition predictor value with at least a portion of the content, and wherein the overall prohibition predictor value is also based at least in part on the regular-expression-based prohibition predictor value.

3. The content characterization system of claim 1, further comprising a named entity recognizer which is configured to, upon execution with the processor, recognize in the content from the data buffer an entity belonging to a data category, and compare the data category of the recognized entity with an expected data category of the data buffer, and associate an entity-recognition-based prohibition predictor value with at least a portion of the content, and wherein the overall prohibition predictor value is also based at least in part on the entity-recognition-based prohibition predictor value.

4. The content characterization system of claim 3, further comprising a regular expression recognizer which is configured to, upon execution with the processor, recognize an instance of a regular expression in the content from the data buffer, and associate a regular-expression-based prohibition predictor value with at least a portion of the content, and wherein the overall prohibition predictor value is also based at least in part on the regular-expression-based prohibition predictor value.

5. The content characterization system of claim 1, further comprising a gibberish generator, and wherein the TMLBCC embodies a rule produced from training with a nonempty training set that comprises gibberish generated by the gibberish generator and labeled as prohibited content.

6. The content characterization system of claim 1, wherein the TMLBCC embodies a plurality of rules collectively produced using a nonempty set A of words labeled as allowed content plus n-grams of words in set A labeled as allowed content plus a nonempty set P of words in the training set labeled as prohibited content, and without the training set comprising n-grams of all words in set P labeled as prohibited content.

7. The content characterization system of claim 1, wherein the TMLBCC includes a naïve Bayes classifier.

8. The content characterization system of claim 1, wherein the TMLBCC also comprises a natural language identifier which selects a natural language model based at least in part on content read from the data buffer.

9. The content characterization system of claim 1, wherein the TMLBCC embodies a rule which uses capitalization as a factor in generating the overall prohibition predictor value.

10. The content characterization system of claim 1, wherein the TMLBCC includes a binarized model file and is configured to perform the content characterization process without requiring any network transmission.

11. A content characterization process, comprising:
receiving, by a content characterizer, data in a data buffer of an input interface;
generating, by the content characterizer, a suspect content identifier that identifies suspect content in the data from the data buffer, the suspect content including frivolous content; and
linking, by the content characterizer, the suspect content identifier and a prohibition predictor value to the data from the data buffer before the input interface makes at least the data from the data buffer available to a content consumer.

12. The content characterization process of claim 11, wherein the process comprises using regular expression definitions to identify frivolous content that includes words or phrases designated in the content characterizer as profane.

13. The content characterization process of claim 11, wherein the process comprises identifying gibberish as frivolous content.

14. The content characterization process of claim 11, wherein the process comprises using a trained machine learning based content characterizer (TMLBCC) to identify frivolous content.

15. The content characterization process of claim 11, wherein the process comprises using named entity recognition to identify frivolous content.

16. The content characterization process of claim 11, wherein the process comprises using regular expression definitions to identify frivolous content, and then using a trained machine learning based content characterizer (TMLBCC) to identify additional frivolous content or as a basis to change a prohibition predictor value, and then using named entity recognition to identify additional frivolous content or as a basis to change a prohibition predictor value.

17. The content characterization process of claim 11, wherein usage of the process identifies frivolous content in data which represents contact information for a person or entity.

18. A content characterizer creation process, comprising:
obtaining a machine learning model;
training the machine learning model to identify frivolous content through supervised machine learning based at least in part on training set data which is gibberish and is labeled as prohibited; and
training the machine learning model to identify frivolous content through supervised machine learning based at least in part on training set data which is labeled as allowed.

19. The content characterizer creation process of claim 18, wherein the process comprises training the machine learning model using n-grams which are substrings of allowed input and labeled as allowed, training the machine learning model without using n-grams which are substrings of prohibited input, and training the machine learning model using complete words which are labeled as allowed.

20. The content characterizer creation process of claim 18, wherein the process further comprises configuring a content characterizer which uses the trained machine learning model to discard or nullify content that is identified by the content characterizer as being more likely than a determined threshold probability to be frivolous content.
